(19) United States
(12) Patent Application Publication
(10) Pub. No.: US 2024/0426260 A1
(43) Pub. Date: Dec. 26, 2024

(54) REAR ASSEMBLY FOR A TURBOJET ENGINE NACELLE

(71) Applicant: SAFRAN NACELLES, GONFREVILLE-L'ORCHER (FR)

(72) Inventors: François BELLET, MOISSY-CRAMAYEL (FR); Moncef M'HASNI, MOISSY-CRAMAYEL (FR)

(21) Appl. No.: 18/700,340

(22) PCT Filed: Oct. 14, 2022
(86) PCT No.: PCT/FR2022/051948

§ 371 Date: Apr. 11, 2024

(30) Foreign Application Priority Data
Oct. 14, 2021 (FR) 2110922

(51) Int. Cl. F02K 1/82; F02K 1/68

(52) U.S. Cl. CPC F02K 1/822; F02K 1/827; F02K 1/68; F05D 2220/323; F05D 2250/283; F05D 2260/963

(57) ABSTRACT

A rear assembly for a turbojet engine nacelle includes at least one composite wall separating a cold portion from a hot portion comprising an element to be cooled, the composite wall having first and second skins which extend facing the cold portion and the hot portion respectively, and which are separated from one another by a middle assembly having cells delimited by internal walls. The first skin includes a plurality of through-openings connecting the cold portion and the cells, the internal walls having through-openings connecting the cells to one another, and the second skin having a through-opening which has its mouth facing the element to be cooled.

### TECHNICAL FIELD OF THE INVENTION

The invention relates to a rear assembly for a turbojet engine nacelle, as well as to a propulsion assembly comprising a nacelle equipped with such a rear assembly.

### PRIOR ART

An aircraft may be powered by one or more turbojet engines, housed in nacelles attached to the fairing or wing of the aircraft.

A propulsion assembly comprising a nacelle 1 is shown in FIG. 1.

Nacelle 1 has a substantially tubular structure comprising a lip 2 defining an upstream air inlet, an intermediate assembly 3 intended to surround a fan 4 of a turbojet engine 5, a rear assembly 6 comprising a fixed internal structure 7, which may integrate a thrust reverser and a fixed external structure 9. Rear assembly 6 surrounds a combustion chamber, a compressor, and a turbine of the turbojet engine 5. The nacelle generally terminates in an exhaust nozzle 10 downstream of the turbojet engine.

The turbojet engine is of the turbofan type, capable of generating, on the one hand, a flow of hot air or a primary flow 11, coming from the combustion chamber and circulating in a core compartment 12 of the turbojet engine, and on the other hand, a flow of cold air or a secondary flow 13, coming from fan 4 and circulating outside the turbojet engine in an annular space called the cold duct 8, between external fairing 9 and fixed internal structure 7 of the nacelle.

The temperature in core compartment 12 is typically between 100° C. and 400° C., while the temperature in cold duct 8 is typically between −50° C. and 100° C.

As shown in FIG. 2, fixed internal structure 7 comprises walls 20 which separate a cold portion comprising cold duct 8, from a hot portion close to the engine, comprising the core compartment 12. Certain elements contained in this hot portion may be worn or damaged by the thermal stresses caused by the high temperatures which prevail there. This is the case in particular for the bumper and damper devices 23 arranged in the hot portion of the nacelle at an attachment strut 24 as well as opposite said strut 24, and fixed to wall 20 of fixed internal structure 7.

These bumper and damper devices 23 make it possible to limit the movement of fixed internal structure 7, in particular of walls 20, due to mechanical stresses during operation.

FIG. 3 illustrates in detail such a bumper and damper device 23 fixed to one of composite walls 20 of fixed internal structure 7.

Composite wall 20 comprises a first skin 30 which extends facing cold portion 8 and a second skin 32 which extends facing hot portion 12, as well as a middle assembly 34 forming a plurality of cells between first and second skins 30, 32.

Bumper and damper device 23 is located in hot portion 12, and requires cooling in order to prevent damage in the event of too high of a rise in temperature.

Bumper and damper device 23 is fixed to composite wall 20 by means of fastening members 36 which penetrate through first and second skins 30, 32, enabling them to be cooled by contact with the air flow circulating in cold portion 8.

In addition, composite wall 20 defines a through-opening 38 in first and second skins 30, 32, its mouth facing the bumper and damper device, intended to send a portion 40 of the flow of cold air circulating in cold portion 8 towards said bumper and damper device 23 in order to cool it. This type of cooling opening 38 is described in more detail in application FR 3 072 908A1.

These cooling systems for elements of a turbojet engine nacelle may be further improved. Indeed, the holes drilled through the composite wall which are required for the cooling opening 38 and the fastening members 36 of bumper and damper device 23 require additional manufacturing steps and reduce the total surface area of composite wall 20 that is providing acoustic insulation for the turbojet engine.

### PRESENTATION OF THE INVENTION

The invention aims to remedy these disadvantages. To this end, the object of the invention is a rear assembly for a turbojet engine nacelle comprising at least one composite wall intended to separate a cold portion from a hot portion, said rear assembly comprising an element to be cooled, the composite wall comprising first and second skins which extend facing the cold portion and the hot portion respectively, separated from one another by a middle assembly comprising cells delimited by internal walls,

characterized in that the first skin comprises a plurality of through-openings connecting the cold portion and the cells, the internal walls comprising through-openings connecting the cells to each other, and the second skin comprising at least one through-opening which has its mouth facing the element to be cooled.

Such a rear assembly allows improved cooling of the element to be cooled, with a simplified and less expensive assembly, while maintaining maximum acoustic insulation by not having to make use of holes drilled all the way through.

The composite wall may be a wall of a fixed internal structure of a thrust reverser.

Such a wall separates cold and hot regions and benefits greatly from significant acoustic insulation for covering the noise of the turbomachine.

The element to be cooled may be a bumper and damper device fixed to the composite wall. The element to be cooled is fixed to the composite wall by fastening members which penetrate through the second skin, the openings in the internal walls being located closer to the second skin than to the first skin.

Such a feature allows additional cooling of the fastening members, by the air flow in the cells, and makes it possible to eliminate fastening members which penetrate all the way through.

The fastening members are at a distance from the first skin.

In particular, the fastening members do not penetrate the first skin.

Such fastening members further improve the acoustic insulation implemented by the wall.

The cold portion may be a cold duct of the turbojet engine nacelle, and the hot portion is a space for receiving the core compartment of a turbojet engine.

The cold duct is for example an annular space defined by an external fairing of the nacelle and by the composite wall, intended to accommodate a flow of cold air.

The core compartment is an area located between the fixed internal structure of the thrust inverter and the engine.

The cells may be in a honeycomb structure with a square, rectangular, triangular, or hexagonal cross-section in a plane parallel to the first and second skins.

The second skin may comprise a single through-opening which has its mouth facing the element to be cooled, the openings in the internal walls being arranged in a manner that converges towards this single through-opening.

Alternatively, the second skin may comprise a plurality of through-openings which have their mouths all facing the same element to be cooled, respective separate internal openings being arranged in a manner that converges towards each of the through-openings.

The invention also relates to a propulsion assembly comprising a nacelle comprising a rear assembly as described above and a turbojet engine received in the nacelle.

The invention further relates to an aircraft comprising at least one propulsion assembly as described above.

Said aircraft may be an airplane.

### BRIEF DESCRIPTION OF FIGURES

FIG. 1 is a longitudinal sectional view of a propulsion assembly of the prior art, comprising a nacelle and a turbojet engine,

FIG. 2 is a cross-sectional view of the propulsion assembly of FIG. 1,

FIG. 3 is a detailed cross-sectional view of the nacelle of FIGS. 1 and 2,

FIG. 4 is a detailed cross-sectional view of a rear assembly of a nacelle according to the invention, and

FIG. 5 is a sectional view of a middle assembly of the rear assembly of FIG. 4.

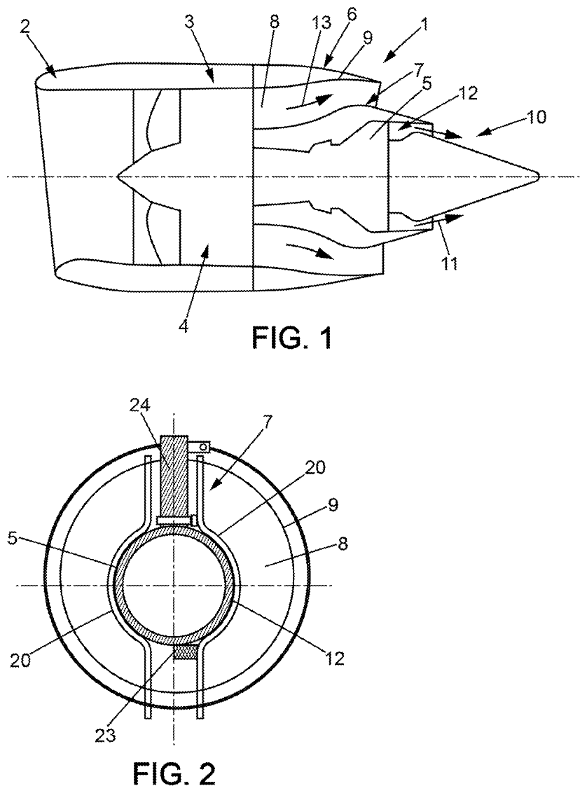

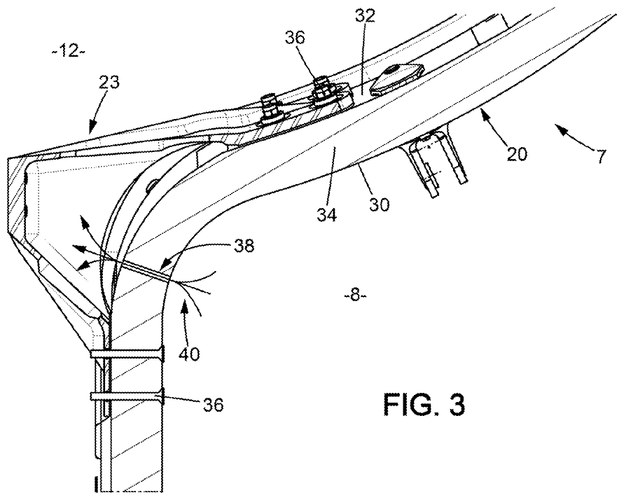

### DETAILED DESCRIPTION OF THE INVENTION

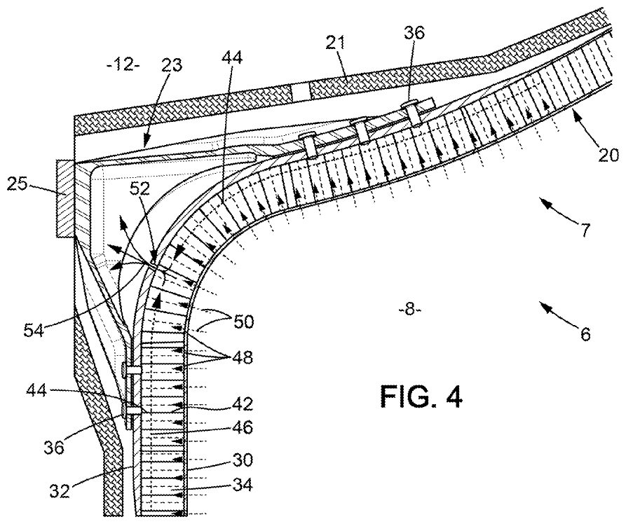

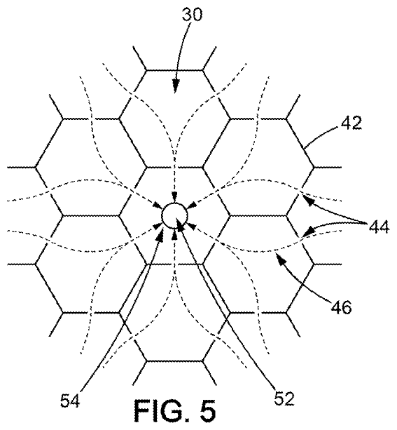

Part of fixed internal structure 7 of a rear assembly 6 of a nacelle according to the invention is shown in FIG. 4. Such a nacelle is part of a propulsion assembly comprising a turbojet engine and a nacelle in which said turbojet engine is housed.

Such a propulsion assembly is intended to equip an aircraft, for example an airplane.

Fixed internal structure 7 is part of rear assembly 6, as explained above, and comprises at least one composite wall 20 separating a hot area 12 comprising the core compartment from a cold area 8 comprising the cold duct in which a flow of cold air circulates.

Fixed internal structure 7 also comprises a thermal protection layer 21 and a bumper and damper device 23 which is fixed to composite wall 20 and comprises a contact element 25 intended to come into contact with the turbojet engine.

Bumper and damper device 23 is located in hot area 12 and is not covered by thermal protection layer 21 in order to be able to bear against the engine, so bumper and damper device 23 needs to be cooled.

Composite wall 20 comprises a first skin 30 and a second skin 32, which extend facing cold area 8 and the hot area 12 respectively.

First and second skins 30, 32 are composite skins, comprising for example glass or carbon fibers embedded in a polymer or resin matrix.

Composite wall 20 further comprises a middle assembly 34 forming a plurality of cells, arranged between and attached to the first and second skins.

Middle assembly 34 is for example a honeycomb type of structure, its cells defined by walls 42 made of metal, polymer, resin, or composite material comprising glass or carbon fibers.

The cells of middle assembly 34 are honeycomb cells which have cross-sections, in a plane locally parallel to first and second skins 30, 32, of square, rectangular, triangular, or hexagonal shape.

As shown in detail in FIG. 5, walls 42 define internal through-openings 44 connecting the cells together, so that an internal air flow 46 can continuously circulate through middle assembly 34. Internal openings 44 may also play a role in draining middle assembly 34.

First skin 30 defines a plurality of through-openings 48 which place cold duct 8 and the cells of middle assembly 34 in communication, so that a flow of cold air 50 can be collected from cold duct 8 and be added to the internal flow 46 circulating in middle assembly 34.

Second skin 32 defines at least one cooling through-opening 52, its mouth facing bumper and damper device 23 and placing middle assembly 34 and hot portion 12 in communication.

Cooling opening 52 makes it possible to concentrate the internal flow 46 circulating in middle assembly 34 into a cooling flow 54 directed towards bumper and damper device 23 in order to cool it.

Cooling opening 52 is not a through-opening through first skin 30, so that no holes drilled all the way through the wall are necessary, which improves the acoustic insulation implemented by composite wall 20.

In the embodiment shown in the figures, there is one cooling opening 52, and openings 44 in internal walls 42 are arranged to converge towards this one through-opening 52, as shown in FIG. 5. Thus, the air flow 46 circulating in middle assembly 34 converges towards cooling opening 52. 10

Alternatively, the second skin may comprise a plurality of cooling openings 52 which have their mouths facing the same element to be cooled 23. In this case, different respective internal openings 44 are arranged so as to converge towards each of cooling openings 52, supplying them all with cold air from cold duct 8.

Bumper and damper device 23 is fixed to second skin 32 by fastening members 36 which penetrate through second skin 32.

Fastening members 36 are cooled by the passage of internal flow 44, and are not in direct contact with cold duct 8.

Internal openings 44 are open in particular in walls 42 of the cells adjacent to said fastening members 36, so as to allow the flow of cold air originating from cold duct 8 to circulate near fastening members 36. This allows cooling the fastening members 36 and bumper and damper device 23 more effectively.

Fastening members 36 do not penetrate through first skin 30, so no holes need to be drilled through the wall here either, which further improves the acoustic insulation implemented by composite wall 20. 25

Advantageously, internal openings 44 are located closer to second skin 32 than to first skin 30, in order to bring internal flow 44 closer to fastening members 36 and improve their cooling. The nacelle according to the invention thus allows improving the cooling of bumper and damper device 23 as well as of fastening members 36, by presenting a larger surface area for the 30 collection of cold air than that of pre-existing devices, and by circulating the cold air in middle assembly 34 of wall 20.

In addition, this cooling method allows completely eliminating any holes drilled all the way through composite wall 20, which improves its acoustic insulation and simplifies its manufacture.

The invention may be extended to any type of element which requires cooling and is fixed to a composite wall separating a cold portion from a hot portion, in particular to other elements fixed to a wall of fixed internal structure 7 of nacelle 1.

1. A rear assembly (6) for a turbojet engine nacelle (1) comprising:
at least one composite wall (20) intended to separate a cold portion (8) from a hot portion (12), said rear assembly (6) comprising an element to be cooled (23), the composite wall (20) comprising first and second skins (30, 32) which extend facing the cold portion (8) and the hot portion (12) respectively, and which are separated from one another by a middle assembly (34) comprising cells delimited by internal walls (42),
characterized in that the first skin (30) comprises a plurality of through-openings (48) connecting the cold portion (8) and the cells, the internal walls (42) comprising through-openings (44) connecting the cells to one another, and the second skin (32) comprising at least one through-opening (52) which has its mouth facing the element to be cooled (23),
wherein the element to be cooled (23) is a bumper and damper device fixed to the composite wall (20) by fastening members (36) which penetrate through the second skin (32), the openings (44) in the internal walls (42) being located closer to the second skin (32) than to the first skin (30).

2. The rear assembly (6) according to claim 1, wherein the composite wall (20) is a wall of a fixed internal structure (7) of a thrust reverser.

3. The rear assembly (6) according to claim 1, wherein the fastening members (36) are at a distance from the first skin (30).

4. The rear assembly (6) according to claim 1, wherein the cold portion (8) is a cold duct of the turbojet engine nacelle (1), and the hot portion (12) is a space for receiving a core compartment of a turbojet engine.

5. The rear assembly (6) according to claim 1, wherein the cells are in a honeycomb structure having a square, rectangular, triangular, or hexagonal cross-section in a plane parallel to the first and second skins (30, 32).

6. The rear assembly (6) according to claim 1, wherein the second skin (32) comprises a single through-opening (52) which has its mouth facing the element to be cooled (23), the openings (44) in the internal walls (42) being arranged in a manner that converges towards this single through-opening (52).

7. The rear assembly (6) according to claim 1, wherein the second skin (32) comprises a plurality of through-openings (52) which have their mouths all facing the same element to be cooled (23), respective separate internal openings (44) being arranged in a manner that converges towards each of the through-openings (52).

8. A propulsion assembly comprising a nacelle (1) comprising a rear assembly (6) according to claim 1 and a turbojet engine (5) received in the nacelle (1).
